(19) United States
(12) Patent Application Publication
(10) Pub. No.: US 2026/0270847 A1
(43) Pub. Date: Sep. 10, 2026

(54) METHOD AND APPARATUS FOR IMPROVEMENTS IN AND RELATING TO AN APPLICATION OF CONTROL PLANE DATA TO LOCAL AREA DATA NETWORK PDU SESSIONS IN A WIRELESS COMMUNICATION SYSTEM

(71) Applicant: Samsung Electronics Co., Ltd., Suwon-si, Gyeonggi-do (KR)

(72) Inventors: Mahmoud WATFA, Staines (GB); Lalith KUMAR, Bangalore (IN)

(21) Appl. No.: 19/165,827

(22) PCT Filed: Apr. 8, 2024
(86) PCT No.: PCT/KR2024/004633

§ 371 Date: Sep. 16, 2025

(30) Foreign Application Priority Data
Apr. 6, 2023 (IN) 202331025940
Mar. 5, 2024 (GB) 2403206.2

(51) Int. Cl. H04W 48/04; H04W 4/021; H04W 76/20

(52) U.S. Cl. CPC H04W 48/04; H04W 4/021; H04W 76/20

(57) ABSTRACT

There is provided a method of performing user data communication between a UE and a network via data transmission on the Control Plane, CP, comprising the steps of: the UE determines if it is inside or outside a LADN service area; if it is inside the LADN service area, the UE is permitted to transmit user data over a Non Access Stratum for an LADN PDU session; and if it is outside the LADN service area, the UE is not permitted to transmit user data over a Non Access Stratum for an LADN PDU session; wherein the user data is cellular internet of things (CIoT) user data.

### Technical Field The present invention relates to a telecommunication system and a method enabling Control Plane (CP) data to Local Area Data Network (LADN) Protocol Data Unit (PDU) sessions.

### Background Art

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial In-telligence) from the design stage and internalizing end-to-end AI support functions, and next-generation distributed computing technology for implementing services at levels of complexity exceeding the limit of UE operation capability by utilizing ultra-high-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different re-quirements, new multiple access schemes to support massive connections, and so on.

The Fifth Generation System (5GS) supports PDU sessions which provided con-nectivity to a Local Area Data Network (LADN) and, as such, these are called LADN PDU sessions. The complete overview of LADN can be found in section 5.6.5 of TS 23.501 V 18.0.0 and in section 6.2.6 of TS 24.501 V 18.1.0 .

### DISCLOSURE OF INVENTION

### Technical Problem

In line with development of the communication systems, there is a need for method for an application of control plane data to local area data network (LADN) PDU sessions. The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

An LADN PDU session can only be established when the UE is in a so called LADN service area, which is defined by a set of tracking areas (TA) where the network provides the LADN service area to the UE.

In addition to being in an LADN service area, in order to be able to establish an LADN PDU session, each PDU session is associated with an LADN DNN (Data Network Name) and, as such, the UE should indicate the DNN for which the LADN PDU session is to be established.

The UE retrieves the LADN DNN information from the AMF as described in section 5.6.5 of TS 23.501 V 18.0.0 and in section 6.2.6 of TS 24.501 V 18.1.0 .

When the UE is requesting a PDU session for LADN, the network verifies if the UE is present in the LADN service area i.e. the UE must be present in the LADN service area. The presence of the UE in an LADN service area, or not, will impact the UE's ability to establish and use the PDU session for LADN.

The applicable 3GPP specification recites:

“When receiving PDU Session Establishment with LADN DNN or Service Request for the established PDU Session corresponding to LADN, the Access and Mobility Management Function (AMF) determines User Equipment (UE) presence in LADN service area and forwards it to the Session Management Function (SMF) if the requested DNN is configured at the AMF as a LADN DNN.

Based on the LADN Service Area Information in the UE, the UE determines whether it is in or out of a LADN service area. If the UE does not have the LADN Service Area Information for a LADN DNN, the UE shall consider it is out of the LADN service area.

The UE takes actions as follows:

a) When the UE is out of a LADN service area, the UE:
shall not request to activate UP connection of a PDU Session for this LADN DNN;
shall not establish/modify a PDU Session for this LADN DNN (except for PS Data Off status change reporting for an established PDU Session);
need not release any existing PDU Session for this LADN DNN unless UE receives explicit SM PDU Session Release Request message from the network.

b) When the UE is in a LADN service area, the UE:
may request a PDU Session Establishment/Modification for this LADN DNN;
may request to activate UP connection of the existing PDU Session for this LADN DNN.

NOTE 6: The evaluation of Service Area Restrictions will be performed before the evaluation of LADN service area, if the UE has overlapping areas between Service Area Restrictions and LADN service area.

The SMF supporting a DNN is configured with information about whether this DNN is a LADN DNN or not.

When receiving SM request corresponding an LADN from the AMF, the SMF determines whether the UE is inside LADN service area based on the indication (i.e. UE Presence in LADN service area) received from the AMF. If the SMF does not receive the indication, the SMF considers that the UE is outside of the LADN service area. The SMF shall reject the request if the UE is outside of the LADN service area.”

The above passage illustrates two points. The first is that the activation or use of an LADN PDU session requires the UE to be inside the LADN service area, and the second being that the actions which the UE is allowed to do (or not do, based on its presence relative to the LADN service area) is about the activation of user-plane (UP) resources for the PDU session. The second is that the other action which the UE may perform when it is inside the service area relates to the modification of the PDU session but normally this modification is also related to UP resources e.g. having a certain Quality of Service, QoS, treatment for the UP resources or data.

The 5GS supports the transport of data over the control plane amongst other features for Cellular Internet of Things (CIoT). The use of control plane to transfer data for IoT is called Control Plane (CP) CIoT 5GS optimization.

For example, the UE may send data over the control plane from idle mode by transitioning to connected mode and sending the Control Plane Service Request (CPSR) message which also includes the actual data to transfer.

However, when the UE is already in connected mode, the UE uses the UL NAS TRANSPORT message, which is another NAS message, to transfer the data (over the CP). In the downlink, the network sends data to the UE encapsulated in the DL NAS TRANSPORT message.

As the name suggests, the transfer of the data over the control plane does not require the UP to be established. However, in some cases, the UE with a PDU session for CP CIoT 5GS optimization may have a larger amount of data to send such that the UE may request the network to establish UP in order to send the data. This is only possible if the PDU session for CP CIoT 5GS optimization is not a session that is indicated to be CP-only and, as such, CP-only sessions cannot admit the use of UP.

A problem is that LADN PDU sessions are associated with user-plane but no indication is provided as to whether they can be used for CP data transfer. As stated earlier, the UE behaviour with respect LADN PDU session focuses only on the conditions that permit the request for UP resources. The 3GPP specifications have not addressed if CP data transfer can occur via a PDU session for LADN, for which there may be two assumptions.

If it is assumed that indeed LADN PDU session can only be used for PDU sessions which use UP only, then there is no description as to how the network would react if it receives a request for establishing a PDU session from a UE which only supports CP CIoT 5GS optimization and hence can only request PDU sessions for data transfer via the CP. As such this missing behaviour needs to be addressed to avoid undefined behaviour of the UE or network.

If it is assumed that LADN PDU session can also be used to transfer data over the CP, then the current requirements on the UE or the network are insufficient as they only address UP resource requests and do not cater for data over the CP. Again, the behaviour is not defined if a UE attempts to use an LADN PDU session for data over NAS, and moreover what the UE or the network need to do in terms of data over NAS when the UE location is not inside an LADN service area is unknown, which may lead to inconsistent behaviour.

In summary, the requirements on LADN PDU session are limited to the request and establishment of UP resources but no description is provided for the case of data over NAS (or CP data transfer) using an LADN PDU session. Hence the UE and network behaviour are undefined when, for example, there is a PDU session for CP CIoT 5GS optimization and the UE is outside the service area of the LADN. This can lead to un-standardized behaviour such that UEs may act differently under the same scenario. For example, nothing currently restricts the UE to send data over NAS i.e. over the control plane, when the UE is outside the LADN PDU session. In fact, it is not clear if the UE is allowed to setup such a PDU session and how the network would react to it. If the UE indeed has such a PDU session, the UE is outside of the LADN service area and indeed sends data over the control plane, then it is not clear how the network will react to it i.e. will the network process the data or reject it. All of these are unaddressed in the current specifications and can lead to problems in practice.

According to the present invention there is provided an apparatus and method as set forth in the appended claims. Other features of the invention will be apparent from the dependent claims, and the description which follows.

According to a first aspect of the present invention, there is provided a method of performing user data communication between a User Equipment, UE, and a telecommunication network, via data transmission on the Control Plane, CP, comprising the steps of: the UE determines if it is inside or outside a Local Area Data Network, LADN, service area; if the UE determines it is inside the LADN service area, then the UE is permitted to transmit user data over a Non Access Stratum for an LADN Protocol Data Unit, PDU, session; and if the UE determines it is outside the LADN service area, then the UE is not permitted to transmit user data over a Non Access Stratum for an LADN PDU, session.

In an embodiment, the UE determines if it is inside or outside the LADN service area only when it has data to send to the telecommunication network on the Control Plane.

In an embodiment, if the UE determines it is inside the LADN service area, then it sends the data and if the UE determines it is outside the LADN service area, then it does not send the data until it is inside the LADN service area.

In an embodiment, the UE does not send Control Plane Service Request or UL NAS TRANSPORT messages when it is outside the LADN service area.

In an embodiment, the LADN service area defined by one or more TAI.

According to a second aspect of the present invention, there is provided method of performing user data communication between a User Equipment, UE, and a telecommunication network, via data transmission on the Control Plane, CP, wherein if an Access and Mobility Management Function, AMF, receives Cellular Internet of Things, CIoT, data for an LADN PDU session, the AMF informs a Session Management Function, SMF, of the telecommunication network if the UE is within a LADN service area or not.

In an embodiment, the AMF informs the SMF via an Indication, which is “UE presence in LADN service area”.

In an embodiment, the AMF forwards the CIoT data and, at the same time, indicates US presence information if the PDU Session is LADN and is being used for transmitting CP data.

In an embodiment, CIoT data is included in one of a Control Plane Service Request, CPSR, message or in an UL NAS TRANSPORT message.

According to a third aspect of the present invention, there is provided method of performing user data communication between a User Equipment, UE, and a telecommunication network, via data transmission on the Control Plane, CP, wherein if an Access and Mobility management Function, AMF, of the telecommunication network receives CIoT data from the UE and the AMF determines that data PDU session is an LADN PDU session and the UE is not in the LADN service area, then the AMF sends a Service Accept, Service Reject or DL NAS TRANSPORT message with the 5GMM cause set to #43 “LADN not available”.

In an embodiment, if the AMF receives CIoT data from the UE and the AMF determines that data PDU session is an LADN PDU session and the UE is not in the LADN service area then the AMF does not forward the CIoT data to an SMF of the telecommunication network

In an embodiment, the Service accept message is sent if the AMF received a Control Plane Service Request, CPSR, message.

According to a fourth aspect of the present invention, there is provided apparatus arranged to perform the method of any preceding aspect.

Embodiments of the invention aim to define different solutions which make the behaviour of the UE and the network standardized with respect to the problems identified above. In particular, the solutions provide a standardized method to handle LADN PDU session for control plane CIoT optimization at both the UE and the network.

Disclosed is a method of performing user data communication between a User Equipment, UE, and a telecommunication network, via data transmission on the Control Plane, CP, comprising the steps of: the UE determines if is inside or outside a Local Area Data Network, LADN, service area; if the UE determines it is inside the LADN service area, then the UE is permitted to transmit user data over a Non Access Stratum for an LADN Protocol Data Unit, PDU, session; and if the UE determines it is outside the LADN service area, then the UE is not permitted to transmit user data over a Non Access Stratum for an LADN PDU, session.

In an embodiment, a method performed by a terminal in a wireless communication system, the method comprising: receiving, from an access and mobility management function (AMF), information on a local area data network (LADN); based on the information, identifying whether the terminal is in a LADN service area or out of the LADN service area; and in case that the terminal is in the LADN service area, transmitting, to the AMF, user data via a control plane for a protocol data unit (PDU) session for the LADN; wherein in case that the terminal is out of the LADN service area, the terminal is not allowed to transmit, to the AMF, the user data via the control plane for the PDU session for the LADN. In an embodiment, further comprising: transmitting, to the AMF, a message comprising cellular internet of things (CIoT) user data, wherein information on a terminal presence in the LADN service area is transmitted from the AMF to a session management function (SMF).

In an embodiment, a method performed by an access and mobility management function (AMF) in a wireless communication system, the method comprising: transmitting, to a terminal, information on a local area data network (LADN); in case that the terminal is in a LADN service area, receiving, from the terminal, user data via a control plane for a protocol data unit (PDU) session for the LADN; wherein in case that the terminal is out of the LADN service area, the terminal is not allowed to transmit, to the AMF, the user data via the control plane for the PDU session for the LADN.

In an embodiment, further comprising: receiving, from the terminal, a message comprising cellular internet of things (CIoT) user data; transmitting, to a session management function (SMF), information on a terminal presence in the LADN service area.

In an embodiment, a terminal in a wireless communication system, the terminal comprising: a transceiver; and at least one processor coupled with the transceiver and configured to: receive, from an access and mobility management function (AMF), information on a local area data network (LADN), based on the information, identify whether the terminal is in a LADN service area or out of the LADN service area, and in case that the terminal is in the LADN service area, transmit, to the AMF, user data via a control plane for a protocol data unit (PDU) session for the LADN, wherein in case that the terminal is out of the LADN service area, the terminal is not allowed to transmit, to the AMF, the user data via the control plane for the PDU session for the LADN.

In an embodiment, an access and mobility management function (AMF) in a wireless communication system, the AMF comprising: a transceiver; and at least one processor coupled with the transceiver and configured to: transmit, to a terminal, information on a local area data network (LADN), and in case that the terminal is in a LADN service area, receive, from the terminal, user data via a control plane for a protocol data unit (PDU) session for the LADN, wherein in case that the terminal is out of the LADN service area, the terminal is not allowed to transmit, to the AMF, the user data via the control plane for the PDU session for the LADN.

Although a few preferred embodiments of the present invention have been shown and described, it will be appreciated by those skilled in the art that various changes and modifications might be made without departing from the scope of the invention, as defined in the appended claims.

### Advantageous Effects of Invention

The present disclosure provides an effective and efficient method for an application of control plane data to local area data network (LADN) PDU sessions. Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 shows a configuration of an embodiment of the present invention; and

FIG. 2 shows a flowchart illustrating an embodiment of the present invention.

FIG. 3 illustrates an example of a base station according to various embodiments of the present disclosure; and

FIG. 4 illustrates an example of a terminal according to various embodiments of the present disclosure.

### MODE FOR THE INVENTION

In a first embodiment, the UE does not request LADN DNN when it is using control plane CIoT optimization.

Consider a UE which only supports control plane CIoT 5GS optimization, e.g. the UE does not support data transfer over the user plane or does not support N3 data transfer, then:
The UE should not request LADN DNN information as part of the registration procedure i.e. the UE should not include the LADN indication IE in the Registration Request message
The UE should not request the establishment of a PDU session for LADN. For example, if the UE previously stored LADN DNN information then the UE should not attempt to request the establishment of a PDU session for LADN using of the DNN which corresponds to an LADN DNN

Note that the above means that the UE should now verify for new conditions when it wants to either request LADN DNN information or when it wants to establish a PDU session for LADN.

For example, when the UE wants to request LADN DNN information, the UE may verify if it supports the transfer of data over the user plane and then determines the next step:
If the UE only supports data transfer over the control plane (or if the UE does not support data transfer over the user plane), then the UE should not send any NAS message to request LADN DNN information. Alternatively, if the UE supports data transfer over the user plane, then the UE can send a NAS message (e.g. Registration Request) and include the LADN indication IE as part of the message
If the UE only supports data transfer over the control plane (or if the UE does not support data transfer over the user plane), then the UE should not request the establishment of a PDU session for an LADN DNN. Alternatively, if the UE supports data transfer over the user plane, then the UE can request the establishment of a PDU session for an LADN DNN

As such, the UE behavior should not consider a new condition in order to determine if a request can be made or not.

Alternatively, for a UE which supports data transfer over the user plane, if the UE somehow determines that it can only use data transfer over the control plane (e.g. based on any indication from the network, or based on knowledge of its subscription information which is such that only control plane data transfer is allowed for the UE, or e.g. based on a configuration in the UE such that the UE should only use control plane data transfer), then the above would also apply. As such the UE may actually support user plane data transfer but there may be other reasons (as listed) such that the UE is not allowed to use the user plane for data transfer and so the above would apply in this case as well. This also means that when the UE wants to establish a new PDU session for LADN or wants to request LADN DNN information, the UE would now have to verify for the condition listed above and then decide whether the request can be made or not based on the proposals above.

For the UE which is using control plane CIoT optimization, where the UE either does not support data transfer over the user plane (e.g. the UE indicated that it does not support N3 data transfer using the 5GMM capability IE) or the UE's subscription is such that any PDU session can only be control-plane-only (CP-only) PDU sessions, if the network (e.g. AMF) receives:
A Registration Request with the LADN indication IE, then the AMF should not provide any LADN information to the UE in the Registration Accept message. Alternatively, the AMF may send the LADN information IE to the UE in the Registration Accept message but the contents should be empty. Alternatively, the AMF may send the Registration Reject message in this case and may include any new or existing 5GMM cause value. A new value may indicate that LADN DNN is not supported for the UE optionally not supported for control plane PDU sessions. Note that the new or existing 5GMM cause value can also be sent in the Registration Accept message. The AMF may also include a back-off timer (either a timer that is used for congestion control e.g. T3346, or another BO timer IE) in this case e.g. if the network's policy requires it or if the UE makes numerous requests for this
An UL NAS Transport message which contains a 5GSM message, where optionally the Request type IE is set to “initial request”, and optionally where the DNN field is an LADN DNN, then the network (e.g. AMF) may determine to not accept the request and not forward the 5GSM message to an SMF. The AMF may send the 5GSM message back to the UE using the DL NAS TRANSPORT message and also include a new 5GMM cause value or an existing 5GMM cause value as proposed above. A back-off timer as set out above may also be included.
If the SMF receives a request to establish a new PDU session e.g. the SMF receives a PDU Session Establishment Request message and the DNN is an LADN DNN and the UE is using Control plane CIoT 5GS optimization, the SMF may reject the request and send a 5GSM cause value to indicate that the UE is outside the LADN service area (e.g. 5GSM cause value #46 “Out of LADN service area” can be used) or to indicate that an LADN PDU session is not permitted for a UE which is using control plane CIoT 5GS optimization (where the latter may be a new cause value). Alternatively, a new 5GSM cause value may be defined and used for this purpose. The receipt of any of these 5GSM causes (e.g. new or existing) should lead to the UE not requesting the establishment of the session again. Alternatively, based on local policies or subscription information, the network (e.g. AMF or SMF) may allow the establishment of a new PDU session for LADN however the network may setup the user plane resources for this PDU session for a UE which supports N3 data transfer (or data transfer over the user plane). Therefore, the network may only permit the use of the PDU session with user plane resources

In a second embodiment, a UE can setup PDU session for LADN and use it for control plane CIoT optimization but new requirements are defined. This embodiment assumes that the UE can indeed request a PDU session for LADN, but requirements are now extended to also address the transfer of data over the control plane or over NAS.

There are five options associated with this embodiment.

In a first option, data over control plane is not allowed when a UE is outside the LADN service area. In this option, the UE is not allowed to send data over the control plane (i.e. data over NAS) when the UE is outside the LADN service area. As such, whenever the UE wants to send either the Control Plane Service Request message containing CIoT user data, or when the UE wants to send an UL NAS TRANSPORT message containing CIoT user data, the UE should verify whether or not it is inside the LADN service area (assuming that the PDU session which is being used for sending data over NAS is a PDU session for LADN). Then:
If the UE determines that it is inside the LADN service area (or if the UE determines that it is not outside the LADN service area), the UE can send the NAS message containing the CIoT user data
If the UE determines that the UE is outside the LADN service area (or if the UE determines that it is not inside the LADN service area), then the UE should not send the message or the UE should block sending the message.

Based on the above, the transmission of a NAS message with CIoT user data becomes subject to a new condition that the UE must verify as described above.

To this end, the AMF should send the UE Presence in LADN service area indication (i.e. the AMF should indicate if the UE is in the LADN service area or not) whenever it receives CIoT user data (either in a Control Plane Service Request message or in an UL NAS TRANSPORT message) which must be forwarded to the SMF.

Alternatively, if the AMF receives CIoT user data (either in a Control Plane Service Request (CPSR) message or in an UL NAS TRANSPORT message) and the AMF determines that the PDU session is an LADN PDU session and that the UE is not in the LADN service area, then the AMF may:
Send a Service Reject message or a Service Accept message (optionally in the case of the AMF receiving a CPSR message) and include 5GMM cause set to #43 “LADN not available”.
If the UE receives a Service Accept message or Service Reject message with 5GMM cause set to #43 “LADN not available” after sending a CPSR message which contained CIoT user data, the UE determines that the CIoT user data was not successfully sent. The UE may indicate to the 5GSM entity or the upper layers that the data was not successfully sent. The UE may resend the CIoT user data when it is inside the LADN service area. Alternatively, the UE may perform a registration procedure to request the LADN service area optionally for the LADN DNN which is associated with the PDU session in question
Alternatively, the AMF may send the DL NAS TRANSPORT message with the CIoT user data back to the UE. As such all the proposals above can also be achieved with the DL NAS TRANSPORT and hence can also be applicable. Furthermore the UE behaviour proposed above would apply if the UE had received a DL NAS TRANSPORT message (instead of a Service Accept or Service Reject message)
Send a DL NAS TRANSPORT message (e.g. in the case when the AMF has received an UL NAS TRANSPORT message or any other NAS message including CIoT user data) and optionally include the CIoT user data (which was received from the UE) and optionally a new or existing 5GMM cause value, where for example the existing cause value #43 “LADN not available” may be used
If the UE receives a DL NAS TRANSPORT message with 5GMM cause set to #43 “LADN not available” after sending a CPSR message which contained CIoT user data, the UE determines that the CIoT user data was not successfully sent. The UE may indicate to the 5GSM entity or the upper layers that the data was not successfully sent. The UE may resend the CIoT user data when it is inside the LADN service area. Alternatively, the UE may perform a registration procedure to request the LADN service area optionally for the LADN DNN which is associated with the PDU session in question
Optionally the network (e.g. AMF or SMF) may discard the received CIoT user data and send any of the messages proposed above and take any of the actions proposed above

In a second option, data over control plane is allowed when a UE is outside the LADN service area. In this option, the UE is allowed to send data over the control plane even if the UE is outside the LADN service area. However the UE is not allowed to request the establishment of user plane (i.e. to request a switch from CP to UP) when it is outside the LADN service area.

This UE behaviour may be preconfigured in the UE or may be indicated to the UE e.g. from the network. For example, a new indication may be provided to the UE to indicate the expected behaviour for this aspect. For example a new field (e.g. a bit position) can be defined in a new Information Element (IE) or an existing IE to indicate if data over NAS can be sent exclusively when the UE is inside the LADN service area, or when the UE is both inside the service area and outside the service area. Note that this indication is just an example but more detailed indications can be defined (e.g. with more than just 1 bit) to show any combination of options.

As such the use of 1 bit as explained here is just an example but, in general, any set of indications can be defined to inform the UE about what is permitted in terms of data transfer for an LADN PDU session where optionally the UE is a UE which does not support user plane data transfer (or the UE only supports data transfer over the control plane), or the UE is in NB-IoT, or the UE is using control plane CIoT 5GS optimization, etc.

To enable this, the UE may send a new indication to the network to indicate its support for processing a network indication regarding the sending of data over an LADN PDU session for the condition listed here e.g. for a UE which is using control plane CIoT 5GS optimization. For example, this indication may be sent in any IE of any NAS message. For example the UE may send this new indication in the 5GMM capability IE which can be sent in the Registration Request message, or in any other IE. Alternatively the capability may be sent in a 5GSM capability IE that can be sent in any session management message.

Based on the indication from the network, the UE can then behave accordingly.

For example, if the network indicates that data over NAS can be sent only when the UE is inside the LADN service area, then the UE should enforce this policy and hence only send data over NAS if it is inside the LADN service area.

For example, if the network indicates that data over NAS can be sent even when the UE is outside the LADN service area, then the UE can send data over NAS when it is outside the service area.

In a third option, negotiation with the network to determine if LADN PDU session can be used for control plane CIoT 5GS optimization. In this option, the UE should indicate its support for sending data over control plane for a PDU session for LADN. This may be done by sending a new indication in an existing IE (e.g. 5GMM capability IE, or 5GSM capability IE) or a new IE may be introduced. This indication may be sent in any NAS (mobility management or session management) message.

The network, e.g. based on subscription or other local policies, can indicate in a new IE or an existing IE whether the UE is permitted to establish (and/or use) a PDU session for LADN and to use the PDU session for sending data over the control plane. The network may also indicate if it supports this feature.

For a UE which supports sending data over control plane, optionally using a PDU session for LADN, if the UE receives an indication that the network either supports or permits the UE to do so, then the UE may establish a PDU session for LADN and use it to send data over NAS (and then any of the proposals above may apply). Otherwise if the network indicates that this is not supported/allowed, then the UE should not send any request for establishing a PDU session for LADN while using control plane CIoT 5GS optimization.

In a fourth option, the UE can request a PDU session for LADN while using control plane CIoT 5GS optimization but the session should always have user plane resources established for it. In this solution option, the UE which is using control plane CIoT 5GS optimization can establish a PDU session for LADN, however the PDU session should always have user plane resources established whenever the UE wants to use the PDU session. For example, the UE can only send/receive data on/for this PDU session via the user plane. As such, if the UE sends the Service Request message or Control Plane Service Request message to send/receive data on/for this PDU session (e.g. which is an LADN PDU session), then the UE requests the establishment of the user plane resources for the PDU session by setting the corresponding PDU session ID bit in the Uplink data status IE (which is used to request user plane resources for a PDU session).

Similarly, when the network has data to send to the UE, the network (e.g. SMF) should always request the establishment of, or should always establish, user plane resources for the LAD PDU session and optionally should not use (or allow the use of) control plane for the transfer of data on/for this PDU session.

In this case, the network (e.g. AMF, or SMF) should reject any request of data transfer over the control plane which can come from the UE. For example, if the UE sends the Control Plane Service Request message containing CIoT user data, or the UL NAS TRANSPORT message containing CIoT user data, then the network should not forward the data to the destination, where the destination may be an SMF or another entity inside or outside the 5GC. To reject the message or to not forward the message, all the details that were set out earlier can be used for this purpose and hence would apply e.g. AMF sends Service Reject, or DL NAS TRANSPORT with the CIoT user data that is not set, etc. Alternatively, the network (e.g. AMF or SMF) may discard the CIoT user data and may respond with 5GMM STATUS message or 5GSM STATUS message and include any new or existing 5GMM or 5GSM cause value.

In an alternative, if the UE continues to send data over NAS, then the network may provide a back-off timer to the UE as has been described before. As such all relevant details above would also apply.

In a fifth option, new subscription info to describe if LADN DNN PDU session is allowed with CIoT 5GS optimization.

New subscription information may be defined as follows:
Subscription information to indicate whether a UE which is using control plane CIoT 5GS optimization is allowed to establish a PDU session for LADN
   Alternatively, this may be in combination with any of: a UE which is supportive of control plane only (i.e. does not support data transfer over the user plane); and a UE which is in NB-IoT
Subscription information to indicate if any LADN PDU session can be used to: transfer data over the control plane, or transfer data over the user plane (and as such the PDU session should be used with user plane resources), or both
Subscription information to indicate if the UE is allowed to send data over the control plane while the UE is: inside the LADN service area only, or when the UE is inside or outside the LADN service area only

The above subscription information may be sent from the Unified Data Management (UDM) to the AMF and/or the SMF. Based on the above, or based on other local policies or configurations, the network nodes can take different actions.

For example, if the UE's subscription information (or based on local policies) indicates that a PDU session for LADN is not allowed for the UE (e.g. due to the UE not supporting user plane transfer, or due to the use of control plane CIoT 5GS optimization, etc), then the network should not permit the establishment of a PDU session for LADN for this UE and as such any of the previous details for this objective would apply. Note that the network may still require that the UE is inside the LADN service area and hence the network may also verify for this condition (and so the UE can also verify for this condition to determine if data can be sent or if a PDU session can be established or modified).

For example, if the UE's subscription information (or based on local policies) indicates that a PDU session for LADN is allowed but the UE can only send data when it is inside the LADN service area, then the details previously presented in e.g. in the first option above would apply i.e. the network only accepts data over NAS if it the UE is inside the service area otherwise the data is not accepted (and hence the CIoT user data is either rejected and sent back to the UE with the appropriate NAS message and/or the CIoT user data is discarded).

For example, if the UE's subscription information (or based on local policies) indicates that a PDU session for LADN is allowed but the UE can only send data over the user plane, the then the proposals previously made in e.g. in the fourth option above would apply i.e. the network only accepts data for this PDU session if the data is sent over the user plane. Otherwise, the network would reject the CIoT user data that is sent over NAS (and hence the CIoT user data is either rejected and sent back to the UE with the appropriate NAS message and/or the CIoT user data is discarded). Note that the network may still require that the UE is inside the LADN service area and hence the network may also verify for this condition (and so the UE can also verify for this condition to determine if data can be sent).

For example, if the UE's subscription information permits the UE to send data over NAS and the UE must be inside the LADN service area, then the details set out previously would apply e.g. the details set out in the second option. Similarly, the network may then behave as set out earlier i.e. if the UE sends Note that for any of the above, unless otherwise stated, the network may also additionally verify that the UE is inside the LADN service area as another criterion to determine if data transfer is allowed for a UE or not.

Note that the following is applicable to all the embodiments presented herein. All the details provided herein which are for determining if a PDU session establishment is allowed for a UE can also apply for determining if a PDU session can be modified. As such the details set out can apply to several session management procedures and are not limited to the PDU session establishment procedure only.

The steps set out in this document can apply in any order or combination. The orders of steps or messages used should be considered as examples only and not as limitations or restrictions of the solutions. Hence a different order of steps or actions or messages sent/received can be performed.

The message names included herein are used only for illustration purposes and as such the actual message that may be used can be any of the NAS messages that are already present or that may be defined in the future.

All the details resented above can apply for the case when the UE is either using control plane CIoT 5GS optimization or not, and hence the details are not limited to control plane CIoT 5GS optimization only and as such can be applicable to user plane CIoT 5GS optimization at the very least. Moreover, the details can apply for the case when the UE is in NB-IoT or in WB mode.

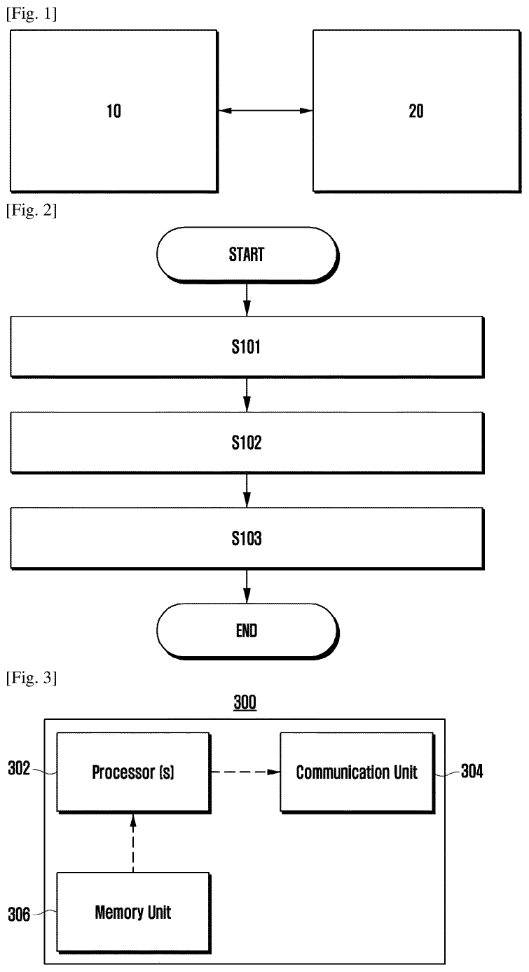

For completeness, FIG. 1 shows an embodiment where a UE 10 is in communication with a network 20.

FIG. 2 shows a flowchart according to an embodiment of the invention. At S101, the UE wishes to perform user data communication between a User Equipment, UE, and a telecommunication network, via data transmission on the Control Plane, CP. At S102, the UE determines if it is inside or outside a Local Area Data Network, LADN, service area. At S103, if the UE determines it is inside the LADN service area, then the UE is permitted to transmit user data over a Non Access Stratum for an LADN Protocol Data Unit, PDU, session or if the UE determines it is outside the LADN service area, then the UE is not permitted to transmit user data over a Non Access Stratum for an LADN PDU, session.

FIG. 3 is a diagram illustrating the configuration of a base station 300 in a wireless communication system, according to an embodiment of the present disclosure. The configuration of FIG. 3 may be understood as a part of the configuration of the BS 300. Referring to FIG. 3, the base station 300 may include at least one processor 302, a communication unit 304 (e.g., communicator or communication interface), and a storage unit 306 (e.g., storage). The communication unit 304 may perform functions for transmitting and receiving signals via a wireless channel.

As an example, the processor 302 may be a single processing unit or a number of units, all of which could include multiple computing units. The processor 302 may be implemented as one or more microprocessors, microcomputers, microcontrollers, digital signal processors, central processing units, state machines, logic circuitries, and/or any devices that manipulate signals based on operational instructions. Among other capabilities, the processor 302 is configured to fetch and execute computer-readable instructions and data stored in the memory. The processor 302 may include one or a plurality of processors. At this time, one or a plurality of processors 302 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 302 may control the processing of the input data in accordance with a predefined operating rule or artificial intelligence (AI) model stored in the non-volatile memory and the volatile memory, i.e., memory unit 306. The predefined operating rule or artificial intelligence model is provided through training or learning.

The memory 306 may include any non-transitory computer-readable medium known in the art including, for example, volatile memory, such as Static Random Access Memory (SRAM) and Dynamic Random Access Memory (DRAM), and/or non-volatile memory, such as Read-Only Memory (ROM), erasable programmable ROM, flash memories, hard disks, optical disks, and magnetic tapes.

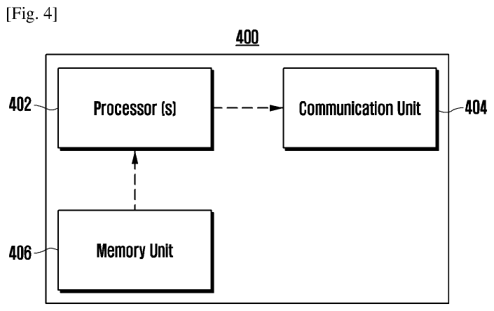

FIG. 4 is a diagram illustrating the configuration of a terminal or a user equipment (UE) 400 in a wireless communication system, according to an embodiment of the present disclosure. The configuration of FIG. 4 may be understood as a part of the configuration of the UE 400. Referring to FIG. 4, the UE 400 may include at least one processor 402, a communication unit 404 (e.g., communicator or communication interface), and a storage unit 406 (e.g., storage). By way of example, the UE 400 may be a User Equipment, such as a cellular phone or other device that communicates over a plurality of cellular networks (such as a 3G, 4G, a 5G or pre-4G, 6G network or any future wireless communication network). The communication unit 404 may perform functions for transmitting and receiving signals via a wireless channel.

As an example, the processor 402 may be a single processing unit or a number of units, all of which could include multiple computing units. The processor 402 may be implemented as one or more microprocessors, microcomputers, microcontrollers, digital signal processors, central processing units, state machines, logic circuitries, and/ or any devices that manipulate signals based on operational instructions. Among other capabilities, the processor 402 is configured to fetch and execute computer-readable instructions and data stored in the memory. The processor 402 may include one or a plurality of processors. At this time, one or a plurality of processors 402 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 402 may control the processing of the input data in accordance with a predefined operating rule or artificial intelligence (AI) model stored in the non-volatile memory and the volatile memory, i.e., memory unit 406. The predefined operating rule or artificial intelligence model is provided through training or learning.

The memory 406 may include any non-transitory computer-readable medium known in the art including, for example, volatile memory, such as Static Random Access Memory (SRAM) and Dynamic Random Access Memory (DRAM), and/or non-volatile memory, such as Read-Only Memory (ROM), erasable programmable ROM, flash memories, hard disks, optical disks, and magnetic tapes.

At least some of the example embodiments described herein may be constructed, partially or wholly, using dedicated special-purpose hardware. Terms such as “component,” “module,” or “unit” used herein may include, but are not limited to, a hardware device, such as circuitry in the form of discrete or integrated components, a field programmable gate array (FPGA) or application specific integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as ap-propriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

Although the present disclosure has been described with various embodiments, various changes and modifications may be suggested to one skilled in the art. It is intended that the present disclosure encompass such changes and modifications as fall within the scope of the appended claims.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as ap-propriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method performed by a terminal in a wireless communication system, the method comprising:
receiving, from an access and mobility management function (AMF), information on a local area data network (LADN);
based on the information, identifying whether the terminal is in a LADN service area or out of the LADN service area; and
in case that the terminal is in the LADN service area, transmitting, to the AMF, user data via a control plane for a protocol data unit (PDU) session for the LADN;
wherein in case that the terminal is out of the LADN service area, the terminal is not allowed to transmit, to the AMF, the user data via the control plane for the PDU session for the LADN.

2. The method of claim 1,
wherein the user data is transmitted by a non-access stratum (NAS) message.

3. The method of claim 1,
wherein the user data is cellular internet of things (CIoT) user data.

4. The method of claim 1, further comprising:
transmitting, to the AMF, a message comprising cellular internet of things (CIoT) user data,
wherein information on a terminal presence in the LADN service area is transmitted from the AMF to a session management function (SMF).

5. A method performed by an access and mobility management function (AMF) in a wireless communication system, the method comprising:
transmitting, to a terminal, information on a local area data network (LADN);
in case that the terminal is in a LADN service area, receiving, from the terminal, user data via a control plane for a protocol data unit (PDU) session for the LADN;
wherein in case that the terminal is out of the LADN service area, the terminal is not allowed to transmit, to the AMF, the user data via the control plane for the PDU session for the LADN.

6. The method of claim 5,
wherein the user data is transmitted by a non-access stratum (NAS) message,
wherein the user data is cellular internet of things (CIoT) user data.

7. The method of claim 5, further comprising:
receiving, from the terminal, a message comprising cellular internet of things (CIoT) user data;
transmitting, to a session management function (SMF), information on a terminal presence in the LADN service area.

8. A terminal in a wireless communication system, the terminal comprising:
a transceiver; and
at least one processor coupled with the transceiver and configured to:
receive, from an access and mobility management function (AMF), information on a local area data network (LADN),
based on the information, identify whether the terminal is in a LADN service area or out of the LADN service area, and
in case that the terminal is in the LADN service area, transmit, to the AMF, user data via a control plane for a protocol data unit (PDU) session for the LADN,
wherein in case that the terminal is out of the LADN service area, the terminal is not allowed to transmit, to the AMF, the user data via the control plane for the PDU session for the LADN.

9. The terminal of claim 8,
wherein the user data is transmitted by a non-access stratum (NAS) message.

10. The terminal of claim 8,
wherein the user data is cellular internet of things (CIoT) user data.

11. The terminal of claim 8, wherein the at least one processor is configured to
transmit, to the AMF, a message comprising cellular internet of things (CIoT) user data,
wherein information on a terminal presence in the LADN service area is transmitted from the AMF to a session management function (SMF).

12. An access and mobility management function (AMF) in a wireless communication system, the AMF comprising:
a transceiver; and
at least one processor coupled with the transceiver and configured to:
transmit, to a terminal, information on a local area data network (LADN), and
in case that the terminal is in a LADN service area, receive, from the terminal, user data via a control plane for a protocol data unit (PDU) session for the LADN,
wherein in case that the terminal is out of the LADN service area, the terminal is not allowed to transmit, to the AMF, the user data via the control plane for the PDU session for the LADN.

13. The AMF of claim 12,
wherein the user data is transmitted by a non-access stratum (NAS) message.

14. The AMF of claim 12,
wherein the user data is cellular internet of things (CIoT) user data.

15. The AMF of claim 12, wherein the at least one processor is configured to:
receive, from the terminal, a message comprising cellular internet of things (CIoT) user data, and
transmit, to a session management function (SMF), information on a terminal presence in the LADN service area.
